(19) United States
(12) Patent Application Publication
(10) Pub. No.: US 2010/0070582 A1
(43) Pub. Date: Mar. 18, 2010

(54) Device Management Across Firewall Architecture

(76) Inventor: Viswanath Somasekhar, Bangalore Karnataka (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 11/993,021

(22) PCT Filed: Jul. 4, 2005
(86) PCT No.: PCT/IN05/00231

§ 371 Date: Dec. 19, 2007

(51) Int. Cl. G06F 15/16; G06F 21/00; H04L 1/18

(52) U.S. Cl. 709/206; 726/11; 709/224; 713/150; 714/749

(57) ABSTRACT

A technique that provides device management network for managing one or more devices located across a firewall. In one example embodiment, this is achieved by sending an Email, including an EDMP-PDU that uses SMTP, POP3, and/or IMAP as a transport mechanism, by a remote host. The Email sent by the remote host is then received by an agent as the firewall is configured to allow the Email. The agent then parses the received Email and reads it. The agent then initiates an action by creating an SNMP command, to be performed on one of the one or more devices, as a function of the parsed Email.

### TECHNICAL FIELD OF THE INVENTION

The present invention generally relates to device management across a firewall, and more particularly relates to managing a device within a local area network (LAN) coupled to a firewall from a host located outside the firewall.

### BACKGROUND OF THE INVENTION

Computer data processing systems often include a group of peripheral devices, such as printers, fax machines, plotters, projectors and the like, that are connected to a LAN. In general, all of these peripheral devices are network enabled and allow configuring operating parameters and monitor their performance locally. These peripheral devices are usually rich in features and are SNMP (simple network management protocol) enabled. Hence, they can be managed using SNMP managers with the LAN running a TCP/IP (transmission control protocol/Internet protocol). Typically, these devices get connected to the LAN within a corporate network.

Generally, these peripheral devices are protected from external world using the standard firewall technologies. For purposes of security and system integrity, many organizations install firewall that restricts the exchange of information with computers located outside of the organization. Typically, such a firewall is interposed between a local computer data processing system and the Internet to block undesired incoming requests and information. In effect, firewalls have become a single point of network access where traffic can be analyzed and controlled according to parameters such as applications, address, and user, for both incoming traffic from remote users and outgoing traffic to the Internet. Consequently, peripheral devices located within a local computer data processing system that is protected by a firewall cannot be unconditionally accessed from a remote location. Controlling these peripheral devices from outside the firewall requires opening the firewall, which can require organizational level IT approval and is typically not a desired practice amongst organizations.

In general, as features and conveniences offered by these peripheral devices are enhanced, the software controlling these peripheral devices becomes increasingly sophisticated and complex. Installation, troubleshooting, configuring, and monitoring of these peripheral devices often can be difficult, time consuming, and can require specialized knowledge of the peripheral devices. For example, the firewall would prevent devices, such as digital projects located within the firewall from firmware upgrade, monitoring the bulb life, monitoring the fan condition and so on by the remote host. Therefore, it would be desirable to outsource such tasks, to a managed service industry that is remotely located, to reduce costs. This requires the managed service industry to have access to the computer system that is protected by a firewall.

### SUMMARY OF THE INVENTION

According to an aspect of the subject matter, there is provided a method for managing one or more devices via an agent that is within a firewall and a local network by a remote host located outside the firewall, the method including the steps of sending an Email including a desired command and a payload from the remote host, wherein the Email includes a payload data unit (PDU) as defined by an Email device management protocol (EDMP), receiving the Email from the remote host by the agent, parsing the received Email by the agent, reading the parsed Email by the agent, initiating an action by creating an SNMP command to be performed on one of the one or more devices by the agent as a function of the parsed Email.

### BRIEF DESCRIPTION OF THE DRAWINGS

Embodiments of the invention will now be described, by way of example only, with reference to the accompanying drawings in which:

FIG. 1 is a flowchart illustrating an example method of a host initiated command to manage a device located across a firewall according to an embodiment of the present invention.

FIG. 2 is a flowchart illustrating an example method of receiving the host initiated command by an agent to manage a device located within a LAN and across a firewall according to an embodiment of the present invention.

FIG. 3 is a flowchart illustrating an example method of an agent initiated command to communicate with the host located across a firewall according to an embodiment of the present invention.

FIG. 4 is a block diagram illustrating a device management architecture that may be employed according to various embodiments of the present invention shown in FIGS. 1-3.

FIG. 5 is a block diagram illustrating example remote host architecture according to an embodiment of the present invention shown in FIG. 4.

FIG. 6 is a block diagram illustrating an example agent architecture according to an embodiment of the present invention shown in FIG. 4.

FIG. 7 is a block diagram of a typical computer system used for implementing embodiments of the present subject matter shown in FIGS. 1-6.

### DETAILED DESCRIPTION OF THE INVENTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims. Also, the terms “SMTP” and “SMTP protocol” are used interchangeably throughout the document. Further, the terms “host” and “remote host” are used interchangeably through the document. Furthermore, the term “Email” refers to electronic mail, which is the transmission of a message over communication networks. In addition, the term “message” here refers to an EDMP (Email device management protocol) created either by a remote host or an agent located across a firewall for communication between the remote host and the agent via the firewall. Moreover, the term “EDMP-PDU” refers to a PDU that is formed as defined by the EDMP. The term “remote host” refers to a device management station located anywhere outside the firewall.

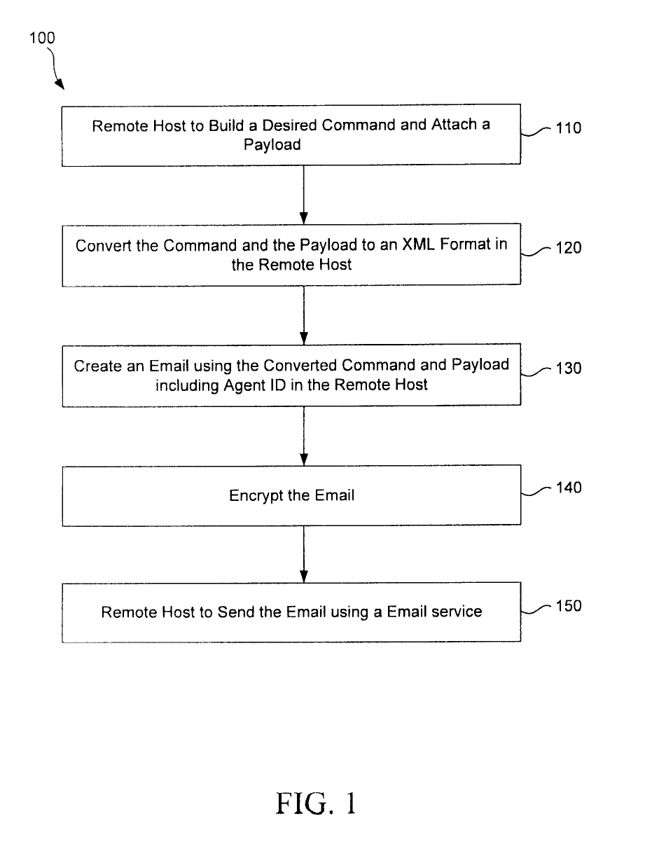

FIG. 1 illustrates an example method 100 of a remote host communicating with a device located across a firewall and within a LAN. At step 110, this example method 100 begins by building a desired command and attaching an EDMP-PDU to communicate with a device located across a firewall by a remote host. Exemplary devices include fax machines, printers, plotters, projectors, and the like. At step 120, the formed command including the payload is converted to formats, such as XML, HTML, delimited text, binary packet and so on.

The following table illustrates some example commands including payloads that may be formed using the XML format to communicate with a device, such as a projector located within a LAN and coupled to a firewall.

| Sr. | | EDMP Structure in XML Format Created by the | |
|---|---|---|---|
| No. | COMMAND | Remote Host | Description |
| 1. | SYNCHRONIZEDB | <protocol_messages><message><header><timest | The log data as |
| | | amp value=“2004-08-13 16:28:37.296- | attachments in the |
| | | 2193”/><orig-timestamp value=“”/><dest- | form of .txt files in |
| | | id>host</dest-id><source-id>2193</source- | xml format to the |
| | | id><message_type | Host from appliance |
| | | value=“request”/></header><command>SYNCHR | |
| | | ONIZEDB</command><payload></payload></mes | |
| | | sage></protocol_messages> | |
| 2. | CONFIGURE | <protocol_messages><message><header><tim | The payload |
| | | estamp value=“2004-08-17 | identifies the device |
| | | 18:46:41.937msp”/><orig-timestamp | and the MIB |
| | | value=“”/><dest-id>2193</dest-id><source- | variable(s) to |
| | | id>host</source-id><message_type | configure together |
| | | value=“request”/></header><command>CON | with the associated |
| | | FIGURE</command><payload><![cdata[<?x | values. The “;;” will |
| | | ml version=“1.0” encoding=“utf-8”?> | mark the end of the |
| | | <payload><device configurable=“false” | payload string. |
| | | macadress=“twc3462031”/><configurations><confi | |
| | | g-oid oid=“1.3.6.1.4.1.11.2.4.3.21.2.29.0” | |
| | | value=“0”/><config-oid | |
| | | oid=“1.3.6.1.4.1.11.2.4.3.21.2.30.0” | |
| | | value=“0”/><config-oid | |
| | | oid=“1.3.6.1.4.1.11.2.4.3.21.2.20.0” | |
| | | value=“0”/></configurations></payload>]]></payloa | |
| | | d></message></protocol_messages> | |
| 3. | DISCOVERY | <protocol_messages><message><header><timest | The command will |
| | LOAD | amp value=“2004-08-13 13:01:22.218msp”/><orig- | carry the seed file |
| | CONFIG | timestamp value=“”/><dest-id>2193</dest- | as attachment and |
| | | id><source-id>host</source-id><message_type | the appliance |
| | | value=“request”/></header><command>DISCOVE | directory to which it |
| | | RYLOADCONFIG</command><payload><![cdata[ | should be persisted |
| | | <?xml version=“1.0” encoding=“utf-8”?> | |
| | | <payload><property name=“agent-id” | |
| | | value=“2193”/></payload>]]></payload></message | |
| | | ></protocol_messages> | |
| 4. | DISCOVERY | <protocol_messages><message><header><timest | Starts the discovery |
| | START | amp value=“2004-08-12 18:16:21.593msp”/><orig- | process for the |
| | | timestamp value=“”/><dest-id>2193</dest- | selected appliance |
| | | id><source-id>host</source-id><message_type | and according to |
| | | value=“request”/></header><command>DISCOVE | the scheduled |
| | | RYSTART</command><payload><![cdata[<?xml | details |
| | | version=“1.0” encoding=“utf-8”?> | |
| | | <payload/>]]></payload></message></protocol_m | |
| | | essages> | |
| 5. | FIRMWARE | <protocol_messages><message><header><timest | Associates group of |
| | DOWNLOAD | amp value=“2004-07-08 17:39:28.64msp”/><orig- | devices with a |
| | | timestamp value=“”/><dest-id>2193</dest- | particular firmware |
| | | id><source-id>host</source-id><message_type | upgrade file and the |
| | | value=“request”/></header><command>FIRMWA | start time to |
| | | REDOWNLOAD</command><payload><![cdata[< | schedule the |
| | | ?xml version=“1.0” encoding=“utf-8”?> | upgrade with |
| | | <payload><device | duration and |
| | | macadress=“twc3432217”/><device | number of |
| | | macadress=“twc3462031”/><firmware><filename> | repetitions for |
| | | c:\program files\apache group\tomcat | retries in case of |
| | | 4.1\temp\host\download\xp8010- | failure. |
| | | scm\4.0.0.85\candelamf4.0.0.85bet1.4.4.dld</filena | |
| | | me><version>4.0.0.85</version><release- | |
| | | no>144</release-no><release-date>2004-07- | |
| | | 14</release-date><projector-model>xp8010- | |
| | | scm</projector-model><firmware- | |
| | | name>candelamf4.0.0.85bet1.4.4.dld</firmware- | |
| | | name></firmware><schedule-detail><simple- | |
| | | schedule><repeat-count>0</repeat-count><repeat- | |
| | | interval>0</repeat-interval><time-to- | |
| | | schdule>1089190800000</time-to-schdule><time- | |
| | | to-stop-schedule>1089190800000</time-to-stop- | |
| | | schedule><rec-identifier>46</rec- | |
| | | identifier><group>download</group><schedule- | |
| | | id>0</schedule- | |
| | | id><user_code>0</user_code><instant- | |
| | | schedule>false</instant-schedule><schedule- | |
| | | desc/><property name=“retry_interval” | |
| | | value=“0”/><property name=“retry_count” | |
| | | value=“0”/></simple-schedule></schedule- | |
| | | detail></payload>]]></payload></message></proto | |
| | | col_messages> | |
| 6. | ALERT | <protocol_messages><message><header><timest | This is to configure |
| | | amp value=“2004-08-17 02:26:44.906-6”/><orig- | the alert details at |
| | | timestamp value=“”/><dest-id>host</dest- | the appliance side. |
| | | id><source-id>6</source-id><message_type | It carries the alert |
| | | value=“event”/></header><command>ALERT</co | details and |
| | | mmand><payload><![cdata[<?xml version=“1.0” | indicates whether to |
| | | encoding=“utf-8”?> | delete or insert, |
| | | <payload><proj-code>tw42001010</proj- | update the alert |
| | | code><alert-name>FULL POWER MODE</alert- | details |
| | | name><alert-remarks> full power mode trap was | |
| | | generated by tw42001010 with ip address | |
| | | 15.76.102.10 and serial number tw42001010. | |
| | | generated time tue, 17 aug 2004 02:26:43.</alert- | |
| | | remarks><alert-status>open</alert- | |
| | | status></payload>]]></payload></message></prot | |
| | | ocol_messages> | |
| 7. | LOG | <protocol_messages><message><header><timest | The number of files |
| | | amp value=“2004-08-17 18:38:07.656msp”/><orig- | to be sent to the |
| | | timestamp value=“”/><dest-id>2193</dest-id><so | requestor or the |
| | | urce-id>host</source-id><message_type | level of logging to |
| | | value=“request”/></header><command>LOG</co | be set |
| | | mmand><payload><![cdata[<?xml version=“1.0” | |
| | | encoding-“u | |
| | | tf-8”?> | |
| | | <payload><level-of-logging>10000</level-of- | |
| | | logging><name>locallll</name></payload>]]></pay | |
| | | load></message></protocol_messages> | |
| 8. | USER | <protocol_messages><message><header><timest | To configure the |
| | DETAILS | amp value=“2004-08-17 18:33:50.75msp”/><orig- | user details and the |
| | | timestamp value=“”/><dest-id>2193</dest- | shift details at the |
| | | id><source-id>host</source-id><message_type | appliance side. |
| | | value=“request”/></header><command>USERDE | Update, delete and |
| | | TAILS</command><payload><![cdata[<?xml | insert the user |
| | | version=“1.0” encoding=“utf-8”?> | details |
| | | <payload><user-details><user-id>JohnD</user- | |
| | | id><user- | |
| | | name/><Email/><role/><password/></user- | |
| | | details><operation>delete</operation></payload>]] | |
| | | ></payload></message></protocol_messages> | |
| 9. | SETSTATUS | <protocol_messages><message><header><timest | This is to inform the |
| | | amp value=“2004-08-17 14:55:01.062-64”/><orig- | MSP about the |
| | | timestamp value=“”/><dest-id>host</dest- | status of a particular |
| | | id><source-id>64</source-id><message_type | scheduled event at |
| | | value=“request”/></header><command>SETSTAT | the appliance and |
| | | US</command><payload><![cdata[<?xml | update the DB |
| | | version=“1.0” encoding=“utf-8”?> | |
| | | <payload><schedule-id>35</schedule- | |
| | | id><status>success</status><remarks>successfull | |
| | | y set the tw42001010 status to power | |
| | | on&lt;br>&lt;br></remarks></payload>]]></payload | |
| | | ></message></protocol_messages> | |
| 10. | UNSCHEDULE | <protocol_messages><message><header><timest | To request for |
| | | amp value=“2004-08-17 00:11:47.984msp”/><orig- | unscheduling event |
| | | timestamp value=“”/><dest-id>64</dest- | at the appliance |
| | | id><source-id>host</source-id><message_type | side indicating the |
| | | value=“request”/></header><command>UNSCHE | id and the group of |
| | | DULE</command><payload><![cdata[<?xml | the event to be |
| | | version=“1.0” encoding=“utf-8”?> | unscheduled |
| | | <payload><schedule-id>31</schedule- | |
| | | id><group/></payload>]]></payload></message></ | |
| | | protocol_messages> | |
| 11. | GETPROJ | <protocol_messages><message><header><timest | This command will |
| | | amp value=“2004-08-17 05:31:13.046-0”/><orig- | obtain the values |
| | | timestamp value=“2004-08-17 | of indicated oids for |
| | | 05:31:11.046msp”/><dest-id>host</dest- | a group of devices |
| | | id><source-id>0</source-id><message_type | |
| | | value=“request”/></header><command>GETPROJ | |
| | | </command><payload><![cdata[<?xml | |
| | | version=“1.0” encoding=“utf-8”?> | |
| | | <payload><device-config-results><device | |
| | | configurable=“true” ip=“” macadress=“twc3432217” | |
| | | name=“”><config-oid | |
| | | oid=“1.3.6.1.4.1.11.2.4.3.21.3.2.0” | |
| | | value=“20”/><config-oid | |
| | | oid=“1.3.6.1.4.1.11.2.4.3.21.3.5.0” | |
| | | value=“0”/><config-oid | |
| | | oid=“1.3.6.1.4.1.11.2.4.3.21.3.4.0” | |
| | | value=“0”/><config-oid | |
| | | oid=“1.3.6.1.4.1.11.2.4.3.21.3.3.0” | |
| | | value=“0”/></device></device-config- | |
| | | results></payload>]]></payload></message></prot | |
| | | ocol_messages> | |
| 12. | DISCOVERY | <protocol_messages><message><header><timest | The .txt files in XML |
| | RESULT | amp value=“2004-08-17 14:00:35.953-64”/><orig- | format as |
| | | timestamp value=“”/><dest-id>host</dest- | attachments |
| | | id><source-id>64</source-id><message_type | containing the |
| | | value=“request”/></header><command>DISCOVE | discovery results |
| | | RYRESULT</command><payload></payload></m | |
| | | essage></protocol_messages> | |

At step 130, an Email including a EDMP-PDU an Email device management protocol (EDMP) that uses known Email protocols, such as SMTP (simple mail transfer protocol), a POP3 (post office protocol 3), or a IMAP (Internet mail access protocol) is created. In these embodiments, the EDMP includes the converted command and the PDU, such as an agent ID. The EDMP defines a way of sending the command, receiving the response, and also the device initiated alarms using Email as a transport mechanism.

In some embodiments, the PDU includes an agent ID (identification), a target ID, a command, data, and a unique token. The unique token is used for tracking the commands and responses to ensure completeness of the management operation initiated by the user. Exemplary PDU data includes information, such as device IP (internet protocol) address, device name, device specific parameters and its associated values, device firmware necessary to upgrade a device and the like. The EDMP provides the ability to communicate between the agent residing in a LAN within an organization, such as a corporation's firewall and the management stations, residing in a remote host outside the firewall. In these embodiments, the EDMP has the capability to send and receive commands and data from the agent to the management station across the firewall. The Email based communication is generally asynchronous in nature, i.e., the command sent and the result received in response to the command sent are separated by a latency introduced by the Email, SMTP, and processing at the agent. In order to increase the reliability, the EDMP has a built in session manager that maintains a list of commands sent to agents that are coupled to the remote host. In these embodiments, the session manager issues a time stamp based unique token to all the commands that are built and sent to an agent located across the firewall.

In these embodiments, each of the commands created using the above technique carries a unique token along with the PDU. The results generated against these commands return these unique tokens. The session manager verifies the received unique token and associate it with the command sent. The process is termed complete when the unique token matches with one of the commands that were sent from the remote host. Also in these embodiments, there is a time-out period for receiving the result and hence the unique tokens are sent. If this time out period elapses, the session manager resends the command with the same unique token. In an instance where both the results (i.e., the one sent earlier and the one sent after the time-out period) are received by the agent including the same unique token, the first sent result is considered and the second result including the unique token is rejected by the agent.

In some embodiments, the unique token is generated by the remote host upon a user performing a management operation on a digital projector, such as setting brightness, checking for contrast value or device firmware version and so on. An Email is then formed by the remote host using the Email command, the payload, and the unique token.

At step 140, the created Email is encrypted. At step 150, the encrypted Email is sent using an Email service. In these embodiments, the Email is sent using the SMTP protocol. Generally, the protocol used to send the Email depends on the type of Email exchange server used to send the Email. The EDMP includes a set of commands formed described above. Each of these commands have an associated structure and a PDU. These commands are built using a format, such as XML, HTML and the like. A Email including the commands are dispatched to agent located within a firewall using SMTP. At the agent side the Email is retrieved using POP3 and/or IMAP protocols. The agent then extracts the commands and executes the operation. Also in these embodiments, the agent receives the SNMP traps sent by each of the one or more devices. The agent then extracts the alerts associated with each of the SNMP traps and forms associated return EDMP-PDU. The agent then forms an Email including the return EDMP-PDU and sends them across the firewall to the remote host.

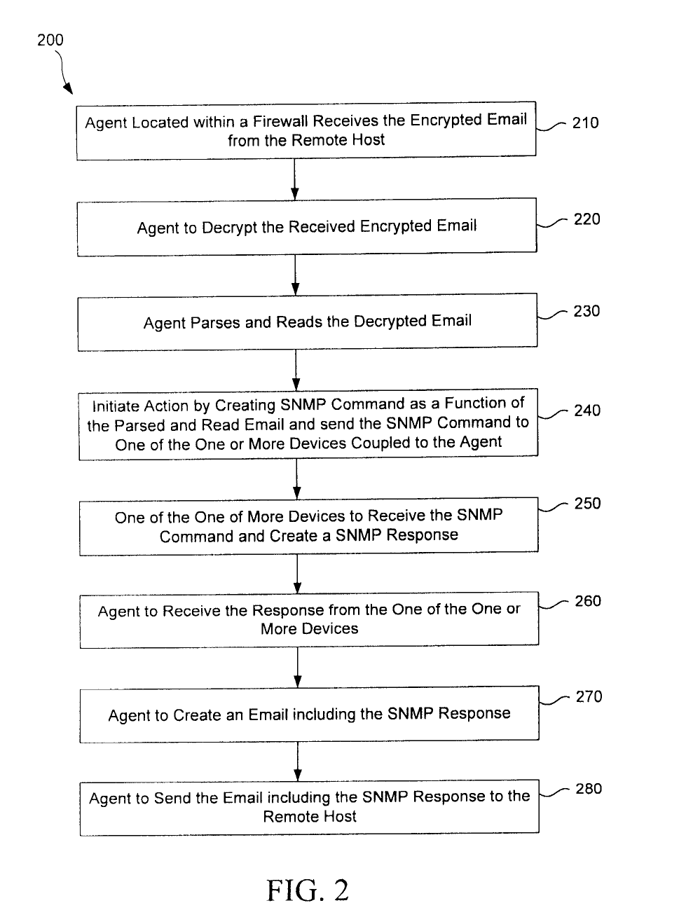

FIG. 2 illustrates an example method 200 of receiving a host initiated command by an agent to manage a device within a LAN. At step 210, this example method 200 begins by receiving the encrypted Email from the remote host by the agent that is within the firewall. At step 220, the received encrypted Email is decrypted by the agent.

At step 230, the agent parses the decrypted Email and reads the parsed Email including the command, the PDU, and the unique token. In some embodiments, the agent stores the read unique token upon parsing the Email. As explained earlier with reference to FIG. 1, the agent then sends an acknowledgement of the receipt of the Email to the remote host. In these embodiments, the remote host then resends the Email upon not receiving an acknowledgement from the agent within a predetermined amount of time of sending the Email. The agent verifies the receipt of the resent Email as a function of the stored unique token. The agent rejects the resent Email if the unique token received is already stored by the agent upon parsing an earlier received Email.

At step 240, the agent initiates an action by creating an SNMP command to be performed on the one of one or more devices coupled within the LAN as a function of the received Email including the EDMP. In these embodiments, the agent creates a SNMP trap using the parsed Email, i.e., the parsed EDMP. In some embodiments, the agent creates a SNMP command as a function of the parsed Email. Also in these embodiments, the agent sends the created SNMP trap to an associated one of the one or more devices coupled to the agent within the LAN.

At step 250, one of the one or more devices receives the SNMP command from the agent. The one of the one or more devices then creates a SNMP response, upon receiving the SNMP command from the agent and completion of the action as a function of the received SNMP command, and sends it to the agent. At step 260, the agent receives the SNMP response from the one of the one or more devices.

At step 270, the agent creates an Email including a return EDMP-PDU. The return EDMP-PDU includes information associated with the received SNMP response. In these embodiments, the Email created by the agent includes the EDMP-PDU which comprises an event generated by the one of the one or more devices and/or a response generated as a function of the SNMP response and PDU. At step 280, the agent sends the Email including the return EDMP-PDU formed as a function of the received SNMP response to the remote host.

The following table illustrates some example Email including return EDMP-PDU formed and communicated by the agent to the remote host upon receiving the SNMP response from the one or more devices, such as a projector coupled to the agent within a LAN coupled to a firewall.

| | | EDMP Structure in XML Format Created by the | |
|---|---|---|---|
| | Command | Agent | Description |
| 1 | CONFIGURE | <protocol_messages><message><header><timest | The oids and the |
| | | amp value=“2004-08-17 05:33:07.265-0”/><orig- | values of each oid |
| | | timestamp value=“2004-08-17 | for each |
| | | 05:32:39.062msp”/><dest-id>host</dest- | device. The status |
| | | id><source-id>0</source-id><message_type | “SUCCESS” |
| | | value=“response”/></header><command>CONFIG | indicates that the |
| | | URE</command><payload><![cdata[<?xml | particular value has |
| | | version=“1.0” encoding=“utf-8”?> | been set |
| | | <payload><device-config-results><device | successfully on the |
| | | configurable=“true” ip=“” macadress=“twc3432217” | device and |
| | | name=“”><config-oid | “FAILURE” |
| | | oid=“1.3.6.1.4.1.11.2.4.3.21.3.5.0” | indicates that the |
| | | status=“success” value=“0”/><config-oid | value could not be |
| | | oid=“1.3.6.1.4.1.11.2.4.3.21.3.4.0” | set on the device |
| | | status=“success” value=“0”/><config-oid | |
| | | oid=“1.3.6.1.4.1.11.2.4.3.21.3.2.0” | |
| | | status=“success” value=“20”/><config-oid | |
| | | oid=“1.3.6.1.4.1.11.2.4.3.21.3.3.0” | |
| | | status=“success” value=“0”/></device></device- | |
| | | config- | |
| | | results></payload>]]></payload></message></prot | |
| | | ocol_messages> | |
| 2 | UNSCHEDULED | <protocol_messages><message><header><timest | This will indicate the |
| | | amp value=“2004-08-17 18:06:08.734-64”/><orig- | status of the |
| | | timestamp value=“2004-08-17 | operation of |
| | | 05:35:15.921msp”/><dest-id>host</dest- | unscheduling an |
| | | id><source-id>64</source-id><message_type | event at the |
| | | value=“response”/></header><command>UNSCH | appliance side. |
| | | EDULE</command><payload><![cdata[<?xml | A value of NO |
| | | version=“1.0” encoding=“utf-8”?> | indicates that the |
| | | <payload><schedule-id>37</schedule- | particular event |
| | | id><operation>yes</operation></payload>]]></payl | could not be |
| | | oad></message></protocol_messages> | unscheduled and |
| | | | value of YES |
| | | | indicates that the |
| | | | event has been |
| | | | unscheduled |
| | | | successfully |
| 3 | GETPROJ | <protocol_messages><message><header><timest | The oids and the |
| | | amp value=“2004-08-17 05:31:13.046-0”/><orig- | values of each oid |
| | | timestamp value=“2004-08-17 | for each |
| | | 05:31:11.046msp”/><dest-id>host</dest- | device. The status |
| | | id><source-id>0</source-id><message_type | “SUCCESS” |
| | | value=“response”/></header><command>GETPR | indicates that the |
| | | OJ</command><payload><![cdata[<?xml | particular value has |
| | | version=“1.0” encoding=“utf-8”?> | been obtained |
| | | <payload><device-config-results><device | successfully on the |
| | | configurable=“true” ip=“” macadress=“twc3432217” | device and |
| | | name=“”><config-oid | “FAILURE” |
| | | oid=“1.3.6.1.4.1.11.2.4.3.21.3.2.0” | indicates that the |
| | | value=“20”/><config-oid | value could not be |
| | | oid=“1.3.6.1.4.1.11.2.4.3.21.3.5.0” | obtained from that |
| | | value=“0”/><config-oid | device |
| | | oid=“1.3.6.1.4.1.11.2.4.3.21.3.4.0” | |
| | | value=“0”/><config-oid | |
| | | oid=“1.3.6.1.4.1.11.2.4.3.21.3.3.0” | |
| | | value=“0”/></device></device-config- | |
| | | results></payload>]]></payload></message></prot | |
| | | ocol_messages> | |

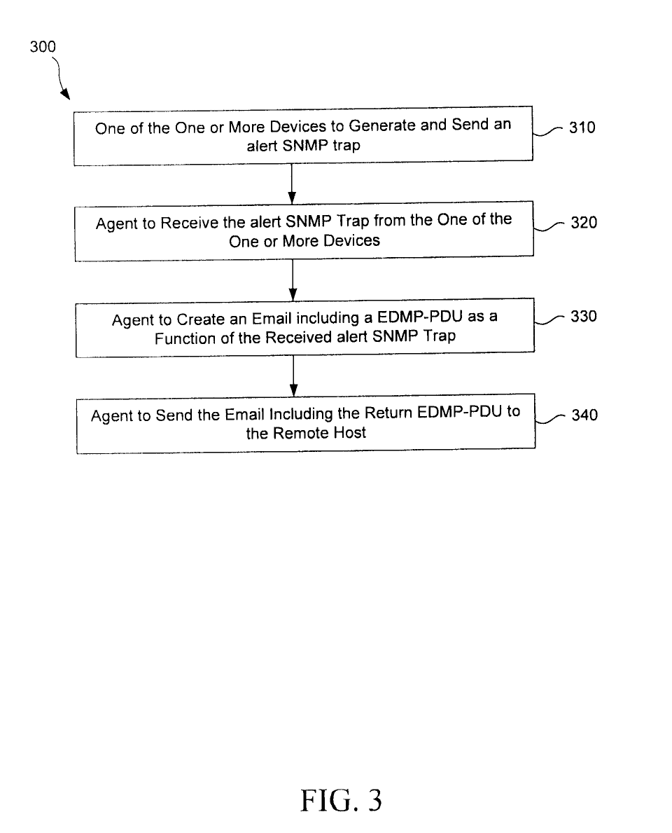

FIG. 3 illustrates an example method 300 of one of the one or more devices communicating with the agent within a LAN. At step 310, this example method 300 begins by sending an alert SNMP trap from the one of the one or more devices to the agent. In some embodiments, the method 300 begins by sending a SNMP response from the one of the one or more devices to the agent.

At step 320, the agent receives the alert SNMP trap from the one of the one or more devices. At step 330, the agent then creates an Email including an EDMP-PDU that is formed based on the alert SNMP trap received from the one of the one or more devices. The result can be an acknowledgement received from the one or more devices. At step 340, the agent then sends for the created Email including the alert EDMP-PDU to the remote host.

The following table illustrates some example Email including the alert EDMP-PDU formed and communicated by the agent to the remote host upon receiving the an alert SNMP trap from the one or more devices, such as a projector coupled to the agent within a LAN coupled to a firewall.

| | Event | EDMP Structure in XML format | Description |
|---|---|---|---|
| 1 | ALERT | <protocol_messages><message><header><timest | Indicates the type of |
| | | amp value=“2004-08-17 02:26:44.906-6”/><orig- | the alert generated |
| | | timestamp value=“”/><dest-id>host</dest- | at the appliance |
| | | id><source-id>6</source-id><message_type | side. Can be traps |
| | | value=“event”/></header><command>ALERT</co | and any thing else |
| | | mmand><payload><![cdata[<?xml version=“1.0” | which has been |
| | | encoding=“utf-8”?> | configured in the |
| | | <payload><proj-code>tw42001010</proj- | alerts by the MSP |
| | | code><alert-name>FULL POWER MODE</alert- | user. (Vishwanath - |
| | | name><alert-remarks> full power mode trap was | please expand the |
| | | generated by tw42001010 with ip address | term ‘MSP”) |
| | | 15.76.102.10 and serial number tw42001010. | |
| | | generated time tue, 17 aug 2004 02:26:43.</alert- | |
| | | remarks><alert-status>open</alert- | |
| | | status></payload>]]></payload></message></prot | |
| | | ocol_messages> | |
| 2 | ACKNOWL- | <protocol_messages><message><header><timest | Indicates the receipt |
| | EDGEMENT | amp value=“2004-08-17 05:20:43.046-0”/><orig- | of a request, |
| | | timestamp value=“”/><dest-id>0</dest-id><source- | response and event |
| | | id>host</source-id><message_type | by either side |
| | | value=“ack”/></header><command>ACKNOWLED | (MSP) or APP. The |
| | | GMENT</command><payload></payload></mess | unique token of the |
| | | age></protocol_messages> | request, response |
| | | | or event is attached |
| | | | as the case may be. |

Although the flowcharts 100, 200, and 300 includes steps 110-150, 210-280, and 310-340 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

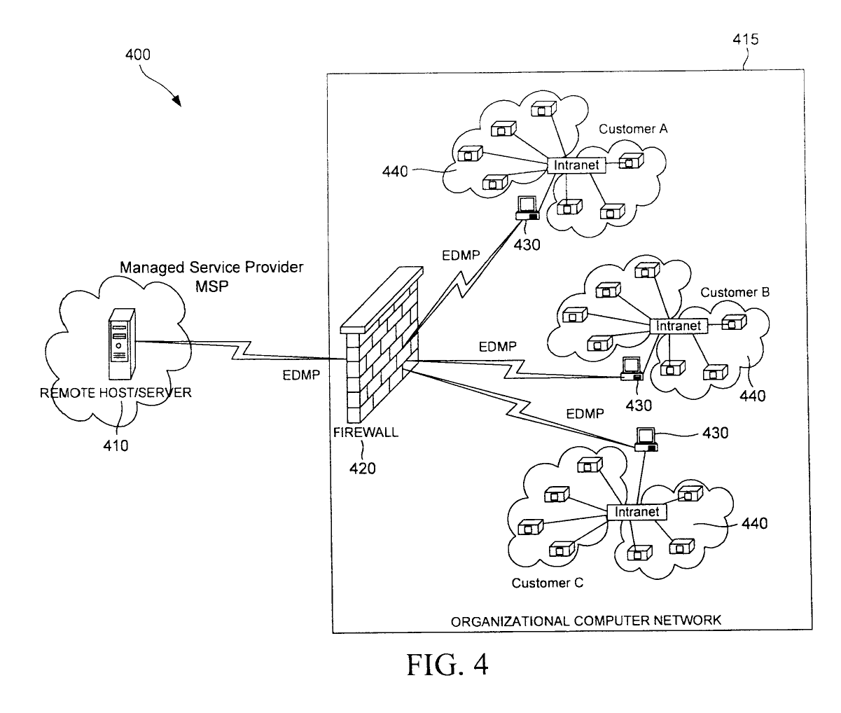

FIG. 4 is a block diagram 400 of example device management architecture for implementing the methods, illustrated in example flowcharts 100-300 shown in FIGS. 1-3, for a host to communicate with one or more devices located across a firewall. The block diagram 400 shown in FIG. 4 includes a remote host 410 communicatively coupled to an organizational computer network 415 via a firewall 420. Further as shown in FIG. 4, the organizational computer network 415 includes one or more agents 430 and associated one or more LAN enabled devices 440 that are coupled to each of the one or more agents 430. Also as shown in FIG. 4, each of the one or more agents 430 are coupled to the remote host 410 via the firewall 420. Exemplary LAN enabled devices 440 include printers, fax machines, plotters, projectors and the like.

In operation, one of the one or more agents 430 receives the Email including an EDMP-PDU that uses SMTP as a transport mechanism. The one of the one or more agents 430 parses the received Email and reads the parsed Email and initiates an action by creating an SNMP command to manage/communicate with the one or more LAN enabled devices 440 as a function of the parsed Email. In these embodiments, the action includes tasks, such as SNMP get, set, start discovery, and store configurations.

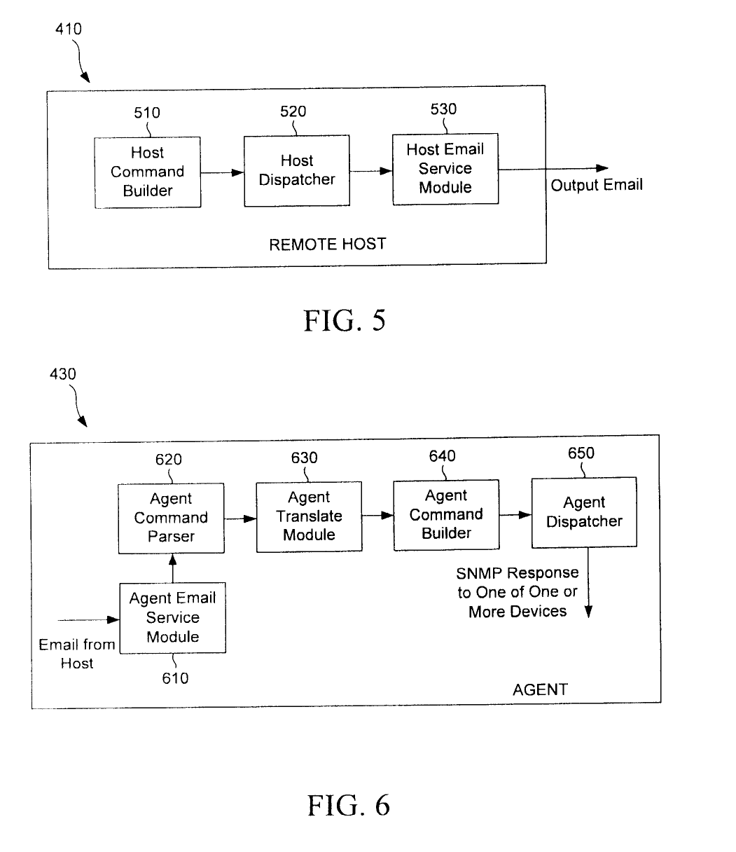

FIG. 5 is a block diagram 500 of example remote host architecture for implementing the method of a remote host communicating with an agent located across a firewall shown in FIG. 1. The block diagram 500 shown in FIG. 5 includes a host command builder 510, a host dispatcher 520, and a host Email service module 530. In operation, builds a desired command by attaching an EDMP-PDU and a unique token to the desired command. In some embodiments, the host command builder 510 then converts the desired command to an XML format.

The host dispatcher 520 then creates an Email which includes the EDMP-PDU along with the unique token in the XML format. The PDU can include device and agent specific parameters, such as agent's email ID, device ID, command, and device specific parameter and its associated values. The host Email service module 530 then dispatches the Email across the firewall 420 using the SMTP transport mechanism.

FIG. 6 is a block diagram 600 of example agent architecture for implementing the method, of an agent communicating with a remote host located across a firewall and one or more devices within a LAN, shown in FIGS. 2-3. As shown in FIG. 6, the block diagram 600 includes an agent Email service module 610, an agent command parser 620, an agent translate module 630, an agent command builder 640, and an agent dispatcher 650. In operation, the agent Email service module 610 receives the Email including the EDMP-PDU along with the unique token from the host Email service module 530 (shown in FIG. 5) via the firewall 420 (shown in FIG. 4). The agent command parser 620 then receives the Email from the agent Email service module 610 and parses the received Email and reads the parsed Email including the EDMP-PDU and the unique token. The agent command parser 620 then initiates an action by creating an SNMP command to be performed on the one of the one or more LAN enabled devices as a function of the parsed and read EDMP-PDU and the unique token.

In some embodiments, the agent translate module 630 then extracts the desired command upon parsing the Email including the EDMP-PDU and translates the parsed Email into the SNMP command. The agent Email service module 610 sends the translated SNMP command to the one of the one or more LAN enabled devices 440 (shown in FIG. 4).

The agent command builder 640 receives a result upon completion of the action associated with the SNMP command sent by the agent Email service module 610 and forms a SNMP response. The agent dispatcher 650 then receives the SNMP response and sends it to the Email service module 610. The Email service module 610 then forms a return EDMP-PDU and sends it to the remote host 410 via the firewall 420 (shown in FIG. 4).

In some embodiments, the one of the one or more LAN enabled devices 440 (shown in FIG. 4) then extracts information associated with the SNMP command and creates any associated alert SNMP traps upon registering the SNMP command received from the agent 430. In these embodiments, the agent command builder 640 then receives the associated alert SNMP traps from the one of the one or more LAN enabled devices 440 (shown in FIG. 4) and forms the SNMP response and passes it to the agent dispatcher 650. The agent dispatcher 650 then sends the SNMP response including the alert SNMP traps to the agent Email service module 610. The agent Email service module 610 forms the return EDMP-PDU and send sit to the remote host 420 via the firewall 410 (shown in FIG. 4). The operation of the device management architecture 400 shown in FIG. 4 is explained in more detail with reference to flowcharts 100-300 shown in FIGS. 1-3.

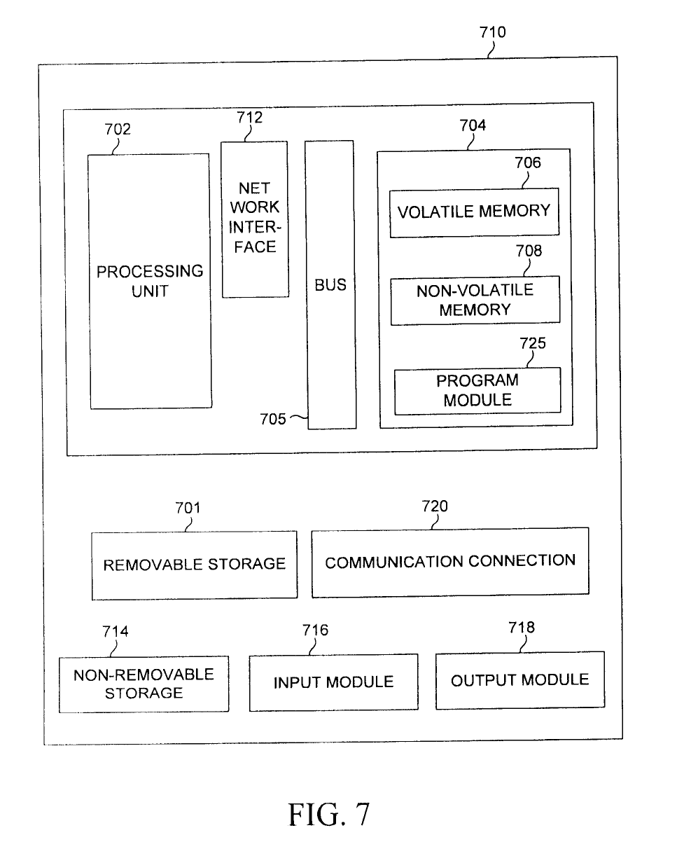

Various embodiments of the present subject matter can be implemented in software, which may be run in the environment shown in FIG. 7 (to be described below) or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 7 shows an example of a suitable computing system environment for implementing embodiments of the present subject matter. FIG. 7 and the following discussion are intended to provide a brief, general description of a suitable computing environment in which certain embodiments of the inventive concepts contained herein may be implemented.

A general computing device, in the form of a computer 710, may include a processing unit 702, memory 704, removable storage 701, and non-removable storage 714. Computer 710 additionally includes a bus 705 and a network interface (NI) 712.

Computer 710 may include or have access to a computing environment that includes one or more user input modules 716, one or more output modules 718, and one or more communication connections 720 such as a network interface card or a USB connection. The one or more output devices 718 can be a display device of computer, computer monitor, TV screen, plasma display, LCD display, display on a digitizer, display on an electronic tablet, and the like. The computer 710 may operate in a networked environment using the communication connection 720 to connect to one or more remote computers. A remote computer may include a personal computer, server, router, network PC, a peer device or other network node, and/or the like. The communication connection may include a LAN, a Wide Area Network (WAN), and/or other networks.

The memory 704 may include volatile memory 706 and non-volatile memory 708. A variety of computer-readable media may be stored in and accessed from the memory elements of computer 710, such as volatile memory 706 and non-volatile memory 708, removable storage 701 and non-removable storage 714. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 702 of the computer 710. For example, a program module 725 may include machine-readable instructions capable of managing one or more peripheral devices located across a firewall according to the teachings and herein described embodiments of the present subject matter. In one embodiment, the program module 725 may be included on a CD-ROM and loaded from the CD-ROM to a hard drive in non-volatile memory 708. The machine-readable instructions cause the computer 710 to provide an integrated platform according to the various embodiments of the present subject matter. As shown, the program module 725 includes commands to manage one or more devices located across a firewall according to various embodiments of the present invention.

The operation of the computer system 700 to provide a device management architecture is explained in more detail with reference to FIGS. 1-6.

This technique provides device management solutions that work within a LAN. The EDMP-PDU and the return EDMP-PDU described above enables the management of devices outside a firewall. Using the above described technique, the devices located within a firewall can be managed using a remote host located outside the firewall. This includes setting device properties and also receiving alerts associated with the SNMP traps generated by each of devices, such as digital projectors, printers, and so on. The above described technique facilitates managed service provides to manage devices located within a firewall via the remote host using the Email including the EDMPs.

The technique offers a new opportunity for managed service providers to manager devices, such as projects, printers, plotters, and other such network devices and elements. The EDMP can be used and extended for any communication across the firewall.

Further, the above description is intended to be illustrative, and not restrictive. Many other embodiments will be apparent to those skilled in the art. The scope of the subject matter should therefore be determined by the appended claims, along with the full scope of equivalents to which such claims are entitled.

It is to be understood that the above-description is intended to be illustrative, and not restrictive. Many other embodiments will be apparent to those of skill in the art upon reviewing the above-description. The scope of the subject matter should, therefore, be determined with reference to the following claims, along with the full scope of equivalents to which such claims are entitled.

As shown herein, the present subject matter can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the methods illustrated in FIG. 1-3 can be performed in a different order from those shown and described herein.

FIGS. 1-7 are merely representational and are not drawn to scale. Certain proportions thereof may be exaggerated, while others may be minimized. FIGS. 1-7 illustrate various embodiments of the subject matter that can be understood and appropriately carried out by those of ordinary skill in the art.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive invention lies in less than all features of a single disclosed embodiment. Thus the following claims are hereby incorporated into the detailed description of the embodiments of the invention, with each claim standing on its own as a separate preferred embodiment.

1. A method for managing one or more devices via an agent located within a firewall and a LAN by a remote host located outside the firewall comprising transmitting an Email from the remote host, wherein the Email includes a EDMP that uses a SMTP, a POP3, or an IMAP as a transport mechanism, to the one or more devices via the agent.

2. The method of claim 1, further comprising:
receiving the Email from the remote host by the agent;
parsing the received Email by the agent;
reading the parsed Email by the agent; and
initiating an action by creating an SNMP command to be performed on one of the one or more devices by the agent as a function of the parsed Email.

3. The method of claim 2, wherein the PDU includes data selected from the group consisting of device IP address, device name, device specific parameters and its associated values, and device firmware to upgrade a device.

4. The method of claim 3, wherein transmitting the Email from the remote host comprises:
generating a unique token by the remote host upon a user performing a management operation;
forming the Email including the Email command, the payload, and the unique token by the remote host;
encrypting the Email by the remote host; and
transmitting the encrypted Email by the remote host.

5. The method of claim 4, wherein receiving the Email from the remote host by the agent located that is within the firewall comprises:
receiving the encrypted Email by the agent; and
decrypting the encrypted Email by the agent.

6. The method of claim 4, further comprising:
storing the unique token by the agent upon parsing the Email; and
sending an acknowledgement of the receipt of the Email to the remote host.

7. The method of claim 6, further comprising:
resending the Email by the remote host upon not receiving the acknowledgement from the agent within a predetermined time of sending the Email; and
verifying the receipt of the Email and rejecting the resent Email as a function of the stored unique token by the agent.

8. The method of claim 4, further comprising:
creating a SNMP command by the agent as a function of the parsed Email received from the remote host; and
sending the SNMP command to an associated one of the one or more devices coupled to the agent within the LAN.

9. The method of claim 8, further comprising:
creating a SNMP response by the associated one of the one or more devices upon receiving the SNMP command sent by the agent and completion of the action associated with the SNMP command; and
sending the SNMP response to the agent.

10. The method of claim 9, further comprising:
receiving the SNMP response from the device by the agent;
creating an Email including a return EDMP-PDU, wherein the return EDMP-PDU to include information associated with the received SNMP response; and
sending the Email including the return EDMP-PDU to the remote host.

11. The method of claim 1, further comprising:
generating an alert SNMP trap by the one of the one or more devices and sending the alert SNMP trap to the agent;
receiving the sent alert SNMP trap from the one of the one or more devices by the agent;
creating an alert EDMP-PDU as a function of the received alert SNMP trap by the agent; and
sending the Email including the alert EDMP-PDU to the remote host by the agent.

12. (canceled)

13. (canceled)

14. (canceled)

15. (canceled)

16. (canceled)

17. (canceled)

18. (canceled)

19. A device management architecture to manage one or more LAN enabled devices using an agent located within a firewall from a remote host located across a firewall using Email including an EDMP that uses a SMTP, a POP3, or an IMAP as a transport mechanism.

20. The architecture of claim 19, wherein the EDMP includes a command, a PDU, and a unique token, and
wherein the agent receives the Email and parses the Email, wherein the agent reads the parsed Email and initiates an action by creating an SNMP command to manage the one or more LAN enabled devices as a function of the parsed Email.

21. The architecture of claim 20, wherein the remote host that forms the Email and sends it to the one or more LAN enabled devices within the firewall comprises:
a host command builder that builds a desired command, wherein the host command builder attaches an EDMP-PDU and a unique token to the desired command, and wherein the host command builder converts the EDMP-PDU and the unique token to an XML format;
a host dispatcher coupled to the host command builder creates an Email which includes the EDMP-PDU along with the unique token in the XML format, and wherein the PDU includes the agent's e-mail ID, device ID, command, and device specific parameter and its associated values; and
a host Email service module that is coupled to the host dispatcher that dispatches the Email across the firewall using the SMTP transport mechanism.

22. The architecture of claim 21, wherein the agent that receives the Email and parses the Email comprises:
an agent Email service module to receive the Email including the EDMP-PDU along with the unique token from the host Email service module via the firewall; and
an agent command parser receives the Email from the agent Email service module and parses the received Email, wherein the command parser reads the parsed Email including the EDMP-PDU along the unique token, and wherein the command parser to initiate an action by creating an SNMP command to be performed on the one of the one or more LAN enabled devices as a function of the parsed EDMP-PDU.

23. The architecture of claim 22, further comprising:
an agent translate module that is coupled to the agent command parser extracts the desired command upon parsing the Email including the EDMP-PDU and translates the parsed EDMP-PDU to the SNMP command and wherein the agent Email service module sends the translated SNMP command to one of the one or more LAN enabled devices as a function of the parsed EDMP-PDU.

24. The architecture of claim 23, wherein the agent further comprises:
an agent command builder that receives a result upon completion of the action associated with the SNMP command sent by the agent Email service module and forms a SNMP response; and
an agent dispatcher coupled to the agent command builder receives the SNMP response and sends it to the agent Email service module, and wherein the agent Email service module receives the SNMP response from the agent dispatcher and forms a return EDMP-PDU and sends it to the remote host via the firewall.

25. The architecture of claim 24, wherein the one of the one or more LAN enabled devices extracts the SNMP command information and create any associated alert SNMP traps upon registering the SNMP command received from the agent, wherein the agent command builder receives the associated alert SNMP traps from the one of the one or more LAN enabled devices and forms the SNMP response and passes it to the agent dispatcher, wherein the agent dispatcher to send the SNMP response including the alert SNMP traps to the agent Email service module, and wherein the agent Email service module forms the return EDMP-PDU and sends it to the remote host via the firewall.

26. A computer system comprising:
a network interface;
an input module coupled to the network interface that receives the input data via the network interface;
a processing unit; and
a memory coupled to the processor, the memory having stored therein code which when decoded by the processor, the code causes the processor to perform a method comprising:
managing one or more devices via an agent within a firewall and a LAN by a remote host located outside the firewall comprising transmitting an Email from the remote host, wherein the Email includes an EDMP that uses a SMTP, a POP3, or an IMAP as a transport mechanism, to the one or more devices via the agent.

27. The system of claim 26, further comprising:
receiving the Email from the remote host by the agent;
parsing the received Email by the agent;
reading the parsed Email by the agent; and
initiating an action by creating an SNMP command to be performed on one of the one or more devices by the agent as a function of the parsed Email.

28. The system of claim 27, wherein transmitting the Email from the remote host comprises:
generating a unique token by the remote host upon a user performing a management operation;
forming the Email including the Email command, the payload, and the unique token by the remote host;
encrypting the Email by the remote host; and
transmitting the encrypted Email by the remote host.

29. The system of claim 28, further comprising:
creating a SNMP command by the agent as a function of the parsed Email received from the remote host; and
sending the SNMP command to an associated one of the one or more devices coupled to the agent within the LAN.

30. The system of claim 29, further comprising:
creating a SNMP response by the associated one of the one or more devices upon receiving the SNMP command sent by the agent and completion of the action associated with the SNMP command; and
sending the SNMP response to the agent.

31. The system of claim 30, further comprising:
receiving the SNMP response from the device by the agent;
creating an Email including a return EDMP-PDU, wherein the return EDMP-PDU to include information associated with the received SNMP response; and
sending the Email including the return EDMP-PDU to the remote host.

32. The system of claim 31, further comprising:
generating an alert SNMP trap by the one of the one or more devices and sending the alert SNMP trap to the agent;
receiving the sent alert SNMP trap from the one of the one or more devices by the agent;
creating an alert EDMP-PDU as a function of the received alert SNMP trap by the agent; and
sending the Email including the alert EDMP-PDU to the remote host by the agent.
